(19) United States
(12) Patent Application Publication
(10) Pub. No.: US 2025/0082002 A1
(43) Pub. Date: Mar. 13, 2025

(54) FOODS THAT MEET PRESCRIBED NUTRITIONAL STANDARDS

(71) Applicant: NISSIN FOODS HOLDINGS CO., LTD., Osaka (JP)

(72) Inventors: Noritaka ANDO, Osaka (JP); Takashi KATO, Osaka (JP); Atsushi ONISHI, Osaka (JP); Takao UCHIDA, Osaka (JP); Toshiyuki FUJIMOTO, Osaka (JP); Toshimitsu HIRATA, Osaka (JP); Fumiyasu OGAWA, Osaka (JP)

(21) Appl. No.: 18/883,289

(22) Filed: Sep. 12, 2024

Related U.S. Application Data
(60) Provisional application No. 63/537,923, filed on Sep. 12, 2023.

(51) Int. Cl. A23L 33/00; A23C 19/00; A23C 20/00; A23L 33/10; A23L 33/16

(52) U.S. Cl. CPC A23L 33/40; A23C 19/00; A23C 20/00; A23L 33/10; A23L 33/16

(57) ABSTRACT

A food is provided that includes cheese and/or imitation cheese and sauce, that meets a predetermined nutritional standard, and that has excellent sensory quality. In the food, the cheese and/or imitation cheese includes 5% by mass or less (including 0% by mass) of a total amount of choline, and/or the sauce includes 40% by mass or more of a total amount of choline, the cheese and/or imitation cheese includes 10% by mass or less (including 0% by mass) of a total amount of magnesium, and/or the sauce includes 40% by mass or more of a total amount of magnesium, and the cheese and/or imitation cheese includes 5% by mass or less (including 0% by mass) of a total amount of calcium, and/or the sauce includes 60% by mass or more of a total amount of calcium.

This application is based on and claims the benefit of priority from U.S. Patent Application No. 63/537,923, filed on 12 Sep. 2023, the content of which is incorporated herein by reference.

### BACKGROUND OF THE INVENTION

### Field of the Invention

This invention relates to a food that meets a predetermined nutritional standard.

### Related Art

In recent years, extending “healthy life expectancy”, a period during which people can go about their daily lives without restrictions for health reasons, has become an important issue in decreasing health care costs and ensuring a prosperous old age.

For example, the Dietary Guidelines for Americans (DGA) and the U.S. Dietary Reference Intake (DRI) establish standards for amounts of energy and nutrients that are desired to be ingested to maintain and promote the nation's health. For example, Patent Document 1 discloses that health status is improved through a continuous intake of a diet meeting a predetermined nutritional standard.
Patent Document 1: WO2022/071479

SUMMARY OF THE INVENTION

In order to maintain a diet meeting a predetermined nutritional standard, a food that is habitually ingested and has excellent sensory quality is desirable. On the other hand, some nutrients have a strong foreign taste and are likely to cause an adverse effect on the sensory quality when attempting to meet a lower limit of the standard.

The present invention is proposed in view of such circumstances, and an object thereof is to provide a food that includes cheese and/or imitation cheese and sauce, that meets a predetermined nutritional standard, and that has excellent sensory quality.

The present inventors have found that a food including cheese and/or imitation cheese and sauce, the sauce including more choline, magnesium, or calcium than in the cheese, can combine meeting of a predetermined nutritional standard and a reduced adverse effect on sensory quality. Thus, the present invention has been completed. More specifically, the present invention provides the following aspects.

(1) A food including:
cheese and/or imitation cheese; and sauce, the food as a whole meeting a predetermined nutritional standard,
the cheese and/or imitation cheese including 5% by mass or less (including 0% by mass) of a total amount of choline included in the food, and/or the sauce including 40% by mass or more of a total amount of choline included in the food, the cheese and/or imitation cheese including 10% by mass or less (including 0% by mass) of a total amount of magnesium included in the food, and/or the sauce including 40% by mass or more of a total amount of magnesium included in the food, and
the cheese and/or imitation cheese including 5% by mass or less (including 0% by mass) of a total amount of calcium included in the food, and/or the sauce including 60% by mass or more of a total amount of calcium included in the food.

(2) The food according to (1), in which the cheese and/or imitation cheese includes 0.3% by mass or more of a total amount of potassium included in the food.

(3) The food according to (1) or (2), further including imitation chicken,
the imitation chicken including 30% by mass or more of a total amount of choline included in the food.

(4) A food including:
cheese and/or imitation cheese; and sauce, the food as a whole meeting a predetermined nutritional standard, and
choline, magnesium, or calcium not being added, by way of a food additive or by way of a yeast, to the cheese and/or imitation cheese, and/or choline, magnesium, or calcium being added, by way of a food additive or by way of a yeast, to the sauce.

(5) The food according to (4), in which potassium is added, by way of a food additive, to the cheese and/or imitation cheese.

(6) The food according to (4) or (5), further including imitation chicken,
choline being added, by way of a food additive or by way of a yeast, to the imitation chicken.

(7) The food according to any of (1) to (6), including sodium in a total amount of 0.5% by mass or less in terms of sodium chloride equivalent.

The present invention provides a food that includes cheese and/or imitation cheese and sauce, that meets a predetermined nutritional standard, and that has excellent sensory quality.

### DETAILED DESCRIPTION OF THE INVENTION

Although embodiments of the present invention will be described hereafter, the present invention is not limited thereto. Note that, the contents disclosed in WO2021/193658 and WO2022/071479 are hereby incorporated by reference.

A food according to one embodiment includes cheese and/or imitation cheese (specifically, cheese, imitation cheese, or a combination thereof; hereinafter also referred to as “cheese, etc.”) and sauce, and, as a whole, meets a predetermined nutritional standard.

The predetermined nutritional standard is not particularly limited, and includes, for example, a portion or all of the Dietary Guidelines for Americans (DGA) or the U.S. Dietary Reference Intake (DRI), or a combination thereof with each other or with another standard. At least standards for choline, magnesium, and calcium are met, and preferably standards for potassium and sodium may also be met. Further preferably, one or more standards for an energy content, an energy ratio, a protein, a lipid, a saturated fatty acid, an unsaturated fatty acid (e.g., n-3 fatty acid, n-6 fatty acid), a carbohydrate (including dietary fiber), dietary fiber, added sugar, sodium, phosphorus, iron, zinc, vitamin A, vitamin D, vitamin E, vitamin K, vitamin B1, vitamin B2, niacin, vitamin B6, vitamin B12, folic acid, vitamin C, chloride, cholesterol, chromium, copper, manganese, molybdenum, selenium, iodine, biotin, or pantothenic acid may also met. Note that, it is preferable that that the standard for each nutrient meets at least one of nutritional standards set by DGA, DRI, etc. The DGA and DRI standards are incorporated herein by reference.

Although amounts of nutrients to be ingested per day are not particularly limited, specific examples thereof are shown in Table 1. Note that, the amounts shown in Table 1 are disclosed independently of each other. An amount of each nutrient in a food is not particularly limited and may be 1/5 to 1/1 times the amount shown in Table 1, specifically 1/3 to 1/2 times.

TABLE 1

| | Lower limit | Upper limit |
|---|---|---|
| Potassium (mg) | 2500.0 | |
| Calcium (mg) | 750.0 | 1352.5 |
| Magnesium (mg) | 370.0 | |
| Phosphorus (mg) | 1000.0 | 1623.0 |
| Iron (mg) | 7.5 | 27.0 |
| Zinc (mg) | 11.0 | 21.6 |
| Copper (mg) | 0.9 | 3.8 |
| Manganese (mg) | 4.0 | 6.0 |
| Iodine (μg) | 130.0 | 1623.0 |
| Selenium (μg) | 30.0 | 243.4 |
| Chromium (μg) | 10.0 | 270.5 |
| Molybdenum (μg) | 30.0 | 324.6 |
| Vitamin A (μg) | 900.0 | 1460.7 |
| Vitamin D (μg) | 8.5 | 54.1 |
| Vitamin E (mg) | 7.0 | 459.8 |
| Vitamin K (μg) | 150.0 | |
| Vitamin B1 (mg) | 1.3 | |
| Vitamin B2 (mg) | 1.5 | |
| Niacin (mg) | 14.0 | 43.3 |
| Vitamin B6 (mg) | 1.4 | 29.8 |
| Vitamin B12 (μg) | 2.4 | |
| Folic acid (μg) | 240.0 | 486.9 |
| Pantothenic acid (mg) | 6.0 | |
| Biotin (μg) | 50.0 | |
| Vitamin C (mg) | 100.0 | |

### (Food)

A food may be a pizza, a lasagna, a pasta, a rice gratin, etc., from the viewpoint of a habitual intake. One or both of cheese, etc. and sauce may meet the below-mentioned requirements. The food is typically, but not exclusively, refrigerated or frozen.

### (Cheese, Etc.)

Cheese refers to a product primarily made up of milk of an animal such as cow, sheep, or goat and produced by adding a lactic acid bacterium and an enzyme such as rennet to the milk for coagulation according to the definition by the FDA. Specific examples thereof include natural cheese, processed cheese, fresh cheese, aged cheese, or the like. Imitation cheese may refer to a cheese-like product in which at least part of fat is non-dairy fat and a solid content is at least partially derived from acid or rennet casein or a casein salt. In some cases, the product may include some non-fat milk solid content and some milk fat.

The cheese, etc. preferably includes 5% by mass or less (including 0% by mass), more preferably 3% by mass or less or 1% by mass or less of a total amount of choline included in the food. Alternatively, it is preferable that choline in not added, by way of a food additive or by way of a yeast, to the cheese, etc.

The cheese, etc. preferably includes 10% by mass or less (including 0% by mass), more preferably 5% by mass or less or 3% by mass or less of a total amount of magnesium included in the food. Alternatively, it is preferable that magnesium is not added, by way of a food additive, to the cheese, etc.

The cheese, etc. preferably includes 5% by mass or less (including 0% by mass), more preferably 3% by mass or less or 1% by mass or less of a total amount of calcium included in the food. Alternatively, it is preferable that calcium is not added, by way of a food additive, to the cheese, etc.

The cheese, etc. preferably includes 0.3% by mass or more, more preferably 0.5% by mass or more or 1.0% by mass or more of a total amount of potassium included in the food. An upper limit of the amount of potassium is not particularly limited and may be 20% by mass or less or 10% by mass or less of a total amount. Alternatively, it is preferable that potassium is added, by way of a food additive, to the cheese, etc.

### (Sauce)

The sauce is not particularly limited and preferred examples include, for example, tomato sauce, bechamel sauce, gochujang sauce, etc.

Sauce preferably includes 40% by mass or more, more preferably 50% by mass or more or 60% by mass or more of a total amount of choline included in the food. Alternatively, it is preferable that choline is added, by way of a food additive or by way of a yeast, to the sauce. Note that, like an example of a pizza described below, if a required amount of choline can be added to a part other than cheese, etc. or sauce (e.g., meat substitute), the requirements described in this paragraph do not have to be met.

The sauce preferably includes 40% by mass or more, more preferably 50% by mass or more or 60% by mass or more of a total amount of magnesium included in the food. Alternatively, it is preferable that magnesium is added, by way of a food additive, to the sauce.

The sauce preferably includes 60% by mass or more, more preferably 70% by mass or more or 80% by mass or more of a total amount of calcium included in the food. Alternatively, it is preferable that calcium is added, by way of a food additive, to the sauce.

Potassium may or may not be added to the sauce by way of a food additive.

### (Other Components)

A food according to the embodiment may or may not include a grain-based (e.g., wheat, rice, and their flours) base material (e.g., noodles, a crust, grains), meat or a meat substitute (e.g., chicken or imitation chicken), various toppings (e.g., oregano, sage, parsley), various spices (e.g., black pepper, bell pepper, nutmeg powder, oregano powder, sage powder, laurel powder, chili powder, ginger), seasoning (e.g., citric acid), or a flavor.

Among them, a grain-based base material. (especially a crust) or a meat substitute (especially imitation chicken) preferably includes choline because of ease of masking an adverse effect of choline on sensory quality. In particular, a meat substitute (especially imitation chicken) preferably includes 30% by mass or more, more preferably 40% by mass or more or 50% by mass or more of a total amount of choline included in the food. Alternatively, it is preferable that choline is added, by way of a food additive or by way of a yeast, to the meat substitute (especially imitation chicken). Note that, a meat substitute is a molded meat-like food material that includes a plant (e.g., soybean) derived protein as a major component (e.g., 10% by mass or more, specifically 25% by mass or more without particular limitation). A meat substitute may include a binding agent (e.g., egg white, starch, a polysaccharide thickener), etc.

### (Material)

A food according to the embodiment may be produced using any material. Vegetables such as garlic or onions or mushrooms (e.g., champignon, porcini mushrooms) may be included.

### (Production Method)

A product according to the embodiment can be manufactured according to a conventional method.

### Examples

Hereinafter, the present invention will be described with reference to Examples in more detail, but the present invention is not limited to these Examples.

### (Pasta)

Pasta products were produced by placing noodles, tomato sauce, imitation cheese, and various toppings in this order into a container and then quickly freezing them to a product temperature of −20° C. or less. Note that, the products were frozen in this example, but could also be chilled. The pasta products include raw materials and nutrients as shown in Table 2. The pasta products all meet the predetermined nutritional standards disclosed in WO2021/193658 and WO2022/071479. Here, the pasta products including choline, magnesium, calcium, and potassium in distributions as shown in Table 3 were produced by adjusting amounts of choline, magnesium, calcium, and potassium added to each of the sauce and the imitation cheese by way of a food additive or by way of a yeast (including no addition). Note that, in Example 1, choline, magnesium, calcium, or potassium was not included, by way of a food additive or by way of a yeast, in the imitation cheese.

TABLE 2

| | | |
|---|---|---|
| sodium | 350 | mg |
| total carbohydrate | 72 | g |
| dietary fiber | 15 | g |
| total sugars | 15 | g |
| added sugars | 5 | g |
| protein | 18 | g |
| vitamin D | 20 | μg |
| calcium | 375 | mg |
| iron | 5.2 | mg |
| potassium | 1356 | mg |
| Vitamin A | 260 | μg |
| Vitamin C | 26 | mg |
| Vitamin E | 4.3 | mg |
| Vitamin K | 34.6 | μg |
| Thiamin | 0.3 | mg |
| Riboflavin | 0.4 | mg |
| Niacin | 5 | mg |
| Vitamin B6 | 0.5 | mg |
| Folic Acid | 400 | μg |
| Vitamin B12 | 2.4 | μg |
| Biotin | 30 | μg |
| Pantothenic Acid | 1.4 | mg |
| Phosphorus | 361 | mg |
| Todine | 89.9 | μg |
| Magnesium | 121 | mg |
| Zinc | 3.2 | mg |
| Selenium | 55 | μg |
| Copper | 0.3 | mg |
| Manganese | 1.1 | mg |
| Chromium | 35 | μg |
| Molybdenum | 48 | μg |
| Chloride | 637 | mg |
| Choline | 158.7 | mg |

TABLE 3

| | Example 1 | | | | Example 2 | | | | Example 3 | | | | Example 4 | | | |
|---|---|---|---|---|---|---|---|---|---|---|---|---|---|---|---|---|
| | Choline | Mg | Ca | K | Choline | Mg | Ca | K | Choline | Mg | Ca | K | Choline | Mg | Ca | K |
| Imitation | 0.0% | 0.9% | 0.2% | 3.3% | 6.0% | 0.9% | 0.2% | 3.3% | 0.0% | 11.0% | 0.2% | [symbol] | 0.0% | [symbol] | [symbol] | 3.3% |
| cheese | | | | | | | | | | | | | | | | |
| Sauce | 100.0% | [symbol] | 97.0% | 91.0% | 94.0% | [symbol] | [symbol] | 91.0% | 100.0% | [symbol] | [symbol] | [symbol] | 100.0% | [symbol] | [symbol] | 91.0% |
| Noodle | 0.0% | [symbol] | 1.9% | 5.3% | 0.0% | [symbol] | 1.9% | [symbol] | 0.0% | [symbol] | [symbol] | [symbol] | 0.0% | [symbol] | [symbol] | [symbol] |
| Spice | 0.0% | 0.7% | 0.9% | 0.4% | 0.0% | [symbol] | 0.9% | [symbol] | 0.0% | [symbol] | 0.9% | [symbol] | 0.0% | [symbol] | [symbol] | [symbol] |

(Numerical values in the table represent percentages by mass relative to a total amount of each of nutrients included in the pasta product) [symbol]
indicates data missing or illegible when filed

The pasta products of Examples were thawed and heated in a microwave oven and then subjected to a sensory evaluation by five panelists. The results are as described below. Example 1: No yeasty odor was perceived, appearance was naturally milky white, which was typical of cheese, and overall appearance of the food was good. No foreign taste (harshness, bitterness) was perceived in the food as a whole. The food as a whole also had a good mouthfeel. Example 2: When the amount of choline included in the imitation cheese was more than 5%, the food as a whole had a noticeable yeasty odor along with a powdery impression. In addition, the imitation cheese had a dull color (not a natural milky white color), making overall appearance of the food unfavorable. Example 3: A buffering effect of Mg caused the cheese, etc. to have a near-neutral pH, so lack of cheesiness was noticeably perceived in the food as a whole. In addition, the food as a whole lost its full flavor and became bland because of the near-neutral pH. Acidity of the tomato was neutralized with the Mg, so the food as a whole had a noticeable foreign taste (harshness and bitterness). Example 4: As the amount of Ca included in the imitation cheese increased, the food as a whole felt noticeably coarser. In addition, a deterioration in texture and feel of the imitation cheese was noticeably perceived.

Sensory evaluation after sprinkling 1200 mg of salt (about 0.6% by mass of the pasta product) on each of the pasta products of Examples showed that all of Examples 1 to 4 had more excellent sensory quality, with a noticeably salty taste. The effect of the invention can be said to be specific to the case meeting the nutritional standard for sodium.

### (Lasagna)

Lasagna products were produced by mixing noodles and Bolognese sauce, placing the resulting mixture into a container, and then placing cut spinach, bechamel sauce, imitation cheese, and various toppings in this order thereon. The resulting lasagna products were then frozen. The lasagna products include raw materials and nutrients as shown in Table 4. The lasagna products all meet the predetermined nutritional standards disclosed in WO2021/193658 and WO2022/071479. Here, the lasagna products including choline, magnesium, calcium, and potassium in distributions as shown in Table 5 were produced by adjusting amounts of choline, magnesium, calcium, and potassium added to each of the sauce and the imitation cheese by way of a food additive or by way of a yeast (including no addition). Note that, in Example 1, choline, magnesium, calcium, or potassium was not included, by way of a food additive or by way of a yeast, in the imitation cheese.

TABLE 4

| | | |
|---|---|---|
| sodium | 360 | mg |
| total carbohydrate | 70 | g |
| dietary fiber | 16 | g |
| total sugars | 17 | g |
| added sugars | 7 | g |
| protein | 20 | g |
| vitamin D | 20 | μg |
| calcium | 385 | mg |
| iron | 5.3 | mg |
| potassium | 1391 | mg |
| Vitamin A | 266 | μg |
| Vitamin C | 26 | mg |
| Vitamin E | 4.4 | mg |
| Vitamin K | 51.4 | μg |
| Thiamin | 0.4 | mg |
| Riboflavin | 0.4 | mg |
| Niacin | 5 | mg |
| Vitamin B6 | 0.5 | mg |
| Folic Acid | 400 | μg |
| Vitamin B12 | 2.4 | μg |
| Biotin | 30 | μg |
| Pantothenic Acid | 1.4 | mg |
| Phosphorus | 370 | mg |
| Iodine | 77.3 | μg |
| Magnesium | 124 | mg |
| Zinc | 3.3 | mg |
| Selenium | 55 | μg |
| Copper | 0.3 | mg |
| Manganese | 1.2 | mg |
| Chromium | 35 | μg |
| Molybdenum | 91 | μg |
| Chloride | 681 | mg |
| Choline | 162.8 | mg |

TABLE 5

| | Example 1 | | | | Example 2 | | | |
|---|---|---|---|---|---|---|---|---|
| | Choline | Mg | Ca | K | Choline | Mg | Ca | K |
| Imitation | 0.0% | 0.4% | 0.1% | 1.6% | 6.0% | 0.4% | 0.1% | 1.6% |
| cheese | | | | | | | | |
| Bolognase | 0.0% | 64.7% | 92.2% | 78.2% | 0.0% | 64.7% | 92.2% | 78.2% |
| sauce | | | | | | | | |
| Bechamel | 100.0% | 17.3% | 2.7% | 14.8% | 94.0% | [symbol] | 2.7% | 14.8% |
| sauce | | | | | | | | |
| Noodle | 0.0% | [symbol] | 1.4% | 3.7% | 0.0% | [symbol] | 1.4% | 3.7% |
| Spice | 0.0% | [symbol] | 3.6% | 1.7% | 0.0% | [symbol] | 3.6% | 1.7% |
| | Example 3 | | | | Example 4 | | | |
| | Choline | Mg | Ca | K | Choline | Mg | Ca | K |
| Imitation | 0.0% | 11.0% | 0.1% | 1.6% | 0.0% | 0.4% | 6.0% | 1.6% |
| cheese | | | | | | | | |
| Bolognase | 0.0% | 54.1% | 92.2% | [symbol] | 0.0% | [symbol] | 86.3% | 78.2% |
| sauce | | | | | | | | |
| Bechamel | 100.0% | 17.3% | 2.7% | 14.8% | 100.0% | 17.3% | 2.7% | 14.8% |
| sauce | | | | | | | | |
| Noodle | 0.0% | [symbol] | 1.4% | 3.7% | 0.0% | 12.8% | 1.4% | [symbol] |
| Spice | 0.0% | [symbol] | 3.6% | 1.7% | 0.0% | [symbol] | 3.6% | 1.7% |

(Numerical values in the table represent percentages by mass relative to a total amount of each of nutrients included in the lasagna product) [symbol]
indicates data missing or illegible when filed

The lasagna products of Examples were thawed and heated in a microwave oven and then subjected to a sensory evaluation by five panelists. The results are as described below. The lasagna product had basically the same evaluation results as for the pasta products. The pasta products are mixed before eating, whereas the lasagna products are eaten as is. Therefore, cheese powder is more easily perceived in the lasagna products than in the pasta products. Example 1: No yeasty odor was perceived, appearance was naturally milky white, which was typical of cheese, and overall appearance of the food was good. No foreign taste (harshness, bitterness) was perceived in the food as a whole. The food as a whole also had a good mouthfeel. Example 2: Since the imitation cheese was placed on top of white sauce, an increased amount of choline resulted in a more noticeable dull color of the food as a whole. Example 3: A buffering effect of Mg caused the cheese, etc. to have a near-neutral pH, so lack of cheesiness was noticeably perceived in the food as a whole. In addition, the food as a whole lost its full flavor and became bland because of the near-neutral pH. Acidity of the tomato was neutralized with the Mg, so the food as a whole had a noticeable foreign taste (harshness and bitterness). Example 4: As the amount of Ca included in the imitation cheese increased, the food as a whole felt noticeably coarser. In addition, a deterioration in texture and feel of the imitation cheese was noticeably perceived.

Sensory evaluation after sprinkling 1200 mg of salt (about 0.6% by mass of the lasagna product) on each of the lasagna products of Examples showed that all, of Examples 1 to 4 had more excellent sensory quality, with a noticeably salty taste. The effect of the invention can be said to be specific to the case meeting the nutritional standard for sodium.

### (Pizza)

The pizza products were produced by placing tomato sauce, imitation cheese, red onion slices, red bell pepper slices, cut spinach, imitation chicken, and gochujang sauce on top of a crust in this order and then frozen. The pizza products include raw materials and nutrients as shown in Table 6. The pizza products all meet the predetermined nutritional standards disclosed in WO2021/193658 and WO2022/071479. Here, the pizza products including choline, magnesium, calcium, and potassium in distributions as shown in Table 7 were produced by adjusting amounts of choline, magnesium, calcium, and potassium added to each of the sauce and the imitation cheese by way of a food additive or by way of a yeast (including no addition). Note that, in Example 1, choline, magnesium, calcium, or potassium was not included, by way of a food additive or by way of a yeast, in the imitation cheese.

TABLE 6

| | | |
|---|---|---|
| sodium | 390 | mg |
| total carbohydrate | 76 | g |
| dietary fiber | 15 | g |
| total sugars | 7 | g |
| added sugars | 2 | g |
| protein | 24 | g |
| vitamin D | 20 | μg |
| calcium | 422 | mg |
| iron | 5.8 | mg |
| potassium | 1526 | mg |
| Vitamin A | 292 | μg |
| Vitamin C | 29 | mg |
| Vitamin E | 4.9 | mg |
| Vitamin K | 39.2 | μg |
| Thiamin | 0.4 | mg |
| Riboflavin | 0.4 | mg |
| Niacin | 5 | mg |
| Vitamin B6 | 0.6 | mg |
| Folic Acid | 400 | μg |
| Vitamin B12 | 2.4 | μg |
| Biotin | 30 | μg |
| Pantothenic Acid | 1.6 | mg |
| Phosphorus | 406 | mg |
| Iodine | 48.7 | μg |
| Magnesium | 136 | mg |
| Zinc | 3.6 | mg |
| Selenium | 55 | μg |
| Copper | 0.3 | mg |
| Manganese | 1 | mg |
| Chromium | 35 | μg |
| Molybdenum | 36 | μg |
| Chloride | 747 | mg |
| Choline | 178.6 | mg |

TABLE 7

| | Example 1 | | | | Example 2 | | | |
|---|---|---|---|---|---|---|---|---|
| | Choline | Mg | Ca | K | Choline | Mg | Ca | K |
| Imitation | 0.0% | 1.1% | [symbol] | [symbol] | [symbol] | 1.1% | 0.2% | [symbol] |
| cheese | | | | | | | | |
| Gochujung | 0.0% | [symbol] | 2.0% | [symbol] | 0.0% | [symbol] | 2.0% | [symbol] |
| sauce | | | | | | | | |
| Tomato | 0.0% | [symbol] | [symbol] | [symbol] | 0.0% | [symbol] | [symbol] | 37.1% |
| sauce | | | | | | | | |
| Crust | 39.8% | 14.6% | 2.3% | 20.1% | [symbol] | [symbol] | [symbol] | [symbol] |
| Imitation | [symbol] | [symbol] | [symbol] | [symbol] | 54.2% | [symbol] | [symbol] | [symbol] |
| chicken | | | | | | | | |
| Topping | 0.0% | [symbol] | [symbol] | [symbol] | 0.0% | [symbol] | [symbol] | [symbol] |

| | |
|---|---|
| Example 3 | Example 4 |

| | Choline | Mg | Ca | K | Choline | Mg | Ca | K |
|---|---|---|---|---|---|---|---|---|
| Imitation | 0.0% | 11.0% | 0.2% | [symbol] | 0.0% | 1.1% | 6.0% | [symbol] |
| cheese | | | | | | | | |
| Gochujung | 0.0% | [symbol] | 2.0% | [symbol] | 0.0% | [symbol] | 2.0% | [symbol] |
| sauce | | | | | | | | |
| Tomato | 0.0% | [symbol] | [symbol] | 37.1% | 0.0% | 69.2% | [symbol] | [symbol] |
| sauce | | | | | | | | |
| Crust | [symbol] | [symbol] | [symbol] | 20.1% | [symbol] | 14.8% | 2.3% | 20.1% |
| Imitation | [symbol] | [symbol] | [symbol] | [symbol] | [symbol] | [symbol] | [symbol] | [symbol] |
| chicken | | | | | | | | |
| Topping | 0.0% | [symbol] | [symbol] | [symbol] | 0.0% | [symbol] | [symbol] | [symbol] |

(Numerical values in the table represent percentages by mass relative to a total amount of each of nutrients included in the pizza product) [symbol]
indicates data missing or illegible when filed

The pizza products of Examples were thawed and heated in an oven and then subjected to a sensory evaluation by five panelists. The results are as described below. Example 1: No yeasty odor was perceived and overall appearance of the food was favorable. No foreign taste (harshness, bitterness) was perceived in the food as a whole. The food as a whole also had a good mouthfeel. Example 2: Unlike the pasta products or the lasagna products, the pizza products were baked, so a yeasty odor was more likely to be generated (strongly perceived) in the food as a whole. Example 3: A buffering effect of Mg caused the cheese, etc. to have a near-neutral pH, so lack of cheesiness was noticeably perceived in the food as a whole. In addition, the food as a whole lost its full flavor and became bland because of the near-neutral pH. However, the pizza products as a whole had less foreign taste (harshness and bitterness) than the pasta products or the lasagna products since the pizza product as a whole had sweetness in addition to acidity of tomato, unlike the pasta products or the lasagna products. Example 4: As the amount of Ca included in the imitation cheese increased, the food as a whole felt noticeably coarser. In addition, a deterioration in texture and feel of the imitation cheese was noticeably perceived.

Sensory evaluation after sprinkling 1200 mg of salt (about 0.6% by mass of the pizza product) on each of the pizza products of Examples showed that all of Examples 1 to 4 had more excellent sensory quality, with a noticeably salty taste. The effect of the invention can be said to be specific to the case meeting the nutritional standard for sodium.

1. A food comprising:
cheese and/or imitation cheese; and sauce,
the food as a whole meeting a predetermined nutritional standard,
the cheese and/or imitation cheese comprising 5% by mass or less (including 0% by mass) of a total amount of choline comprised in the food, and/or the sauce comprising 40% by mass or more of a total amount of choline comprised in the food,
the cheese and/or imitation cheese comprising 10% by mass or less (including 0% by mass) of a total amount of magnesium comprised in the food, and/or the sauce comprising 40% by mass or more of a total amount of magnesium comprised in the food, and
the cheese and/or imitation cheese comprising 5% by mass or less (including 0% by mass) of a total amount of calcium comprised in the food, and/or the sauce comprising 60% by mass or more of a total amount of calcium comprised in the food.

2. The food according to claim 1, wherein the cheese and/or imitation cheese comprises 0.3% by mass or more of a total amount of potassium comprised in the food.

3. The food according to claim 1, further comprising imitation chicken,
the imitation chicken comprising 30% by mass or more of a total amount of choline comprised in the food.

4. A food comprising:
cheese and/or imitation cheese; and sauce,
the food as a whole meeting a predetermined nutritional standard,
choline, magnesium, or calcium not being added, by way of a food additive or by way of a yeast, to the cheese and/or imitation cheese, and/or choline, magnesium, or calcium being added, by way of a food additive or by way of a yeast, to the sauce.

5. The food according to claim 4, wherein potassium is added, by way of a food additive, to the cheese and/or imitation cheese.

6. The food according to claim 5, further comprising imitation chicken,
wherein choline is added, by way of a food additive or by way of a yeast, into the imitation chicken.

7. The food according to claim 1, comprising sodium in a total amount of 0.5% by mass or less in terms of sodium chloride equivalent.
